(19) United States
(12) Patent Application Publication
(10) Pub. No.: US 2023/0115915 A1
(43) Pub. Date: Apr. 13, 2023

(54) SAFETY CAP FOR LABORATORY AND CONSUMABLE CONTAINERS

(71) Applicant: C&S Healthcare Consulting LLC, Metairie, LA (US)

(72) Inventors: Maria Michelle Chester, Metairie, LA (US); Steven M. Sands, Baltimore, MD (US)

(73) Assignee: C&S Healthcare Consulting LLC, Metairie, LA (US)

(21) Appl. No.: 17/498,320

(22) Filed: Oct. 11, 2021

(51) Int. Cl. B65D 41/04; B65D 23/10; B65D 51/24

(52) U.S. Cl. CPC B65D 41/0414; B65D 23/104; B65D 51/242; B65D 2251/02

(57) ABSTRACT

A safety cap for containers that facilitates user handling and transport of the containers. The cap is configured with a bottom end that is engageable with a neck of the container for retention of the cap with the container. A handle extends from a top end of the cap and is configured to allow a user to lift and transport the container with their finger(s), rather than grasping the body of the bottle or the cap.

### BACKGROUND OF THE INVENTION

The present invention relates to laboratory containers, and more particularly, to safety caps for laboratory containers such as carboys, flasks, and bottles (“CONTAINERS”) involving chemicals/reagents/buffers/diluents/solvents/bacterial cultures/viral cultures/bioprocess manufacturing such as vaccine production, etc. Additionally, this novel invention could be applied to consumable products such as food and beverage storage.

In the laboratory, chemical containers can slip while handling. The broken glass pieces and/or spillage of dangerous or hazardous contents can harm the users and/or the lab environment. Likewise, the same general concept applies to consumables.

Other caps do not allow the user to safely handle the container, hence the containers are prone to slipping in the user's hands while handling. Moreover, other caps do not allow for easy opening, and thus leading to accidents in user's attempt to manually open. Lastly, other caps do not include an ergonomic handle mechanism to allow for easy handling, opening, and transport.

As can be seen, there is a need for an improved safety cap for containers that facilitates user handling, opening, and transport.

### SUMMARY OF THE INVENTION

In one aspect of the present invention, a cap for a container is disclosed. The cap includes a base dimensioned to overly a peripheral rim surrounding a neck of the container. A flange protrudes from the bottom of the base and is dimensioned to sealingly engage an interior surface of the neck of the container. A handle extends from a top of the base and is dimensioned to be grasped by finger(s) of a user's hand to handle or transport the container via the cap.

In some embodiments, a plurality of notches are defined in a spaced-apart relation about a circumferential edge surface of the base. The plurality of notches are adapted to manually grasp or receive a prong of a spanner wrench to facilitate a twisting of the cap when engaged within the neck of the container.

In some embodiments, a hose connector barb extends from the top of the base. A conduit extends through the hose connector barb and the base, the conduit providing a fluid path through the cap. In other embodiments, a plurality of hose connector barbs extends from the top of the base.

In other embodiments, a plurality of finger recesses are defined in the fixed or hinged handle and are oriented to support the cap in an upright orientation when supported by a user's fingers received in the plurality of finger recesses. The handle may comprise an arch extending transversely across the base. The plurality of finger recesses are defined in an inner surface of the arch.

In some embodiments, an annular lip protrudes from a bottom end of the stopper. The annular lip provides a retaining engagement of the cap with an exterior surface of the neck.

These and other features, aspects and advantages of the present invention will become better understood with reference to the following drawings, description and claims.

### BRIEF DESCRIPTION OF THE DRAWINGS

FIG. 1 is perspective view of the safety cap for containers shown in use.

FIG. 2 is a front elevation view of the safety cap for containers.

FIG. 3 is a top plan view of the safety cap for containers.

FIG. 4 is a detail perspective view of the safety cap for containers.

FIG. 5 is a perspective view of an alternative embodiment of the safety cap to facilitate fluid transfer for containers.

FIG. 6 is a top perspective view showing a threaded connection of the safety cap to the container.

FIG. 7 is a bottom perspective view showing the threaded connection of the safety cap to the container.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an improved safety cap for containers that facilitates user handling, opening and transport of the containers. The cap is configured with a bottom end that is engageable with a threaded interior surface of a neck of the container for retention of the threaded cap with the container. A handle extends from a top end of the cap. The handle is configured to allow a user to lift and transport the container with their finger(s), rather than manually grasping the bottle or the cap and risking contamination or contact with residual fluids that may be present at the cap. The handle also reduces the risk of dropping the container when grasped about the body of the container.

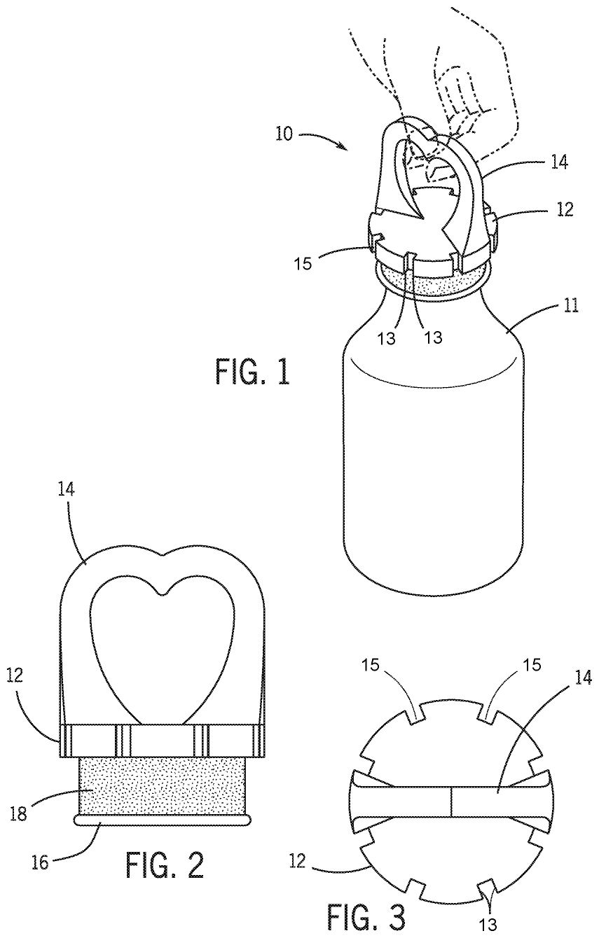

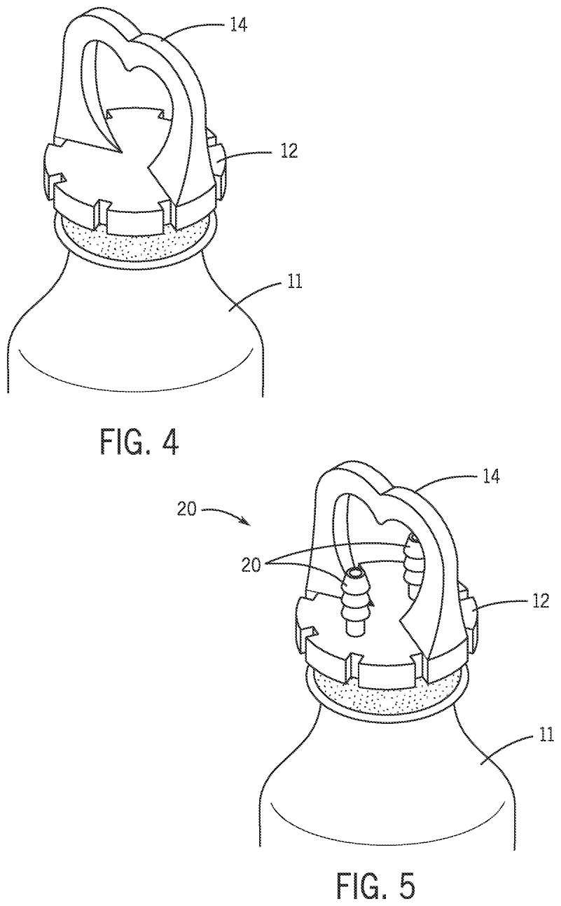

As seen in reference to the drawings of FIGS. 1-5, non-limiting embodiments of a cap 10 for a container 11 are disclosed. The cap 10 includes a base 12 that is dimensioned to overly a peripheral rim surrounding a neck of the container 11. The base 12 may include a plurality of notches 15 defined in a spaced-apart relation about a circumferential edge surface of the base. The plurality of notches 15 are adapted to manually grasp or receive a prong of a tool, such as a spanner wrench, to facilitate a twisting removal of the cap 10 when engaged within the neck of the container 10.

A frosted exterior sleeve for labeling 18 protrudes from a bottom of the base 12. The sleeve 18 is dimensioned to sealingly engage with the neck of the container 11. A diameter of the sleeve 18 is inset from a diameter of the base 12 and is within a circumferential dimension defined by an inner extent of the plurality of notches 15. The inset allows for engagement of the notches 15 by the prong of the tool without obstruction or interference with the sleeve 18.

In some embodiments, an annular lip 16 may be provided that protrudes from a bottom end of the sleeve 18. The annular lip 16 has a diameter slightly greater than that of the sleeve 18.

A handle 14 extends from a top of the base 12 in an upright orientation or at rest if utilizing the hinged mechanism. The handle 14 dimensioned to be grasped by finger(s) of a user's hand to carry the cap 10 and the container 11 when coupled with the cap 10. The handle 14 includes a plurality of finger recesses 17 defined in the handle 14. The finger recesses 17 are oriented to support the cap 10 in an upright orientation when supported by a user's fingers received in the plurality of finger recesses 17. In the embodiments shown, the handle 14 is defined by an arch extending transversely across the base 12. The plurality of finger recesses 14 are defined in an inner surface of the arch.

The handle 14 allows the user to transport or hold the container 11 with their finger(s), rather than manually grasping around the body of the container 11. This provides improved safety in that the container 11 is not prone to slipping in the user's hand. Likewise, the configuration of the handle 14 with the cap 10 allows the user to avoid contacting fluids that may have dripped down the outer sides of the container 11 after contents have been poured or dispensed from the container 11.

In some embodiments, such as shown in FIG. 5, the cap 20 may also include one or more hose connector barbs 22. A conduit extends through the hose connector barb 22, providing a fluid path through the cap 10. As will be appreciated, a plurality of hose connector barbs 22 may be extend from the top of the base 12. The hose connector barbs 22 may be connected with a flexible tubing for evacuating fluids from within the container 11 or for receiving a fluid into the container 11. The hose connector barbs 22 may also be provided for venting of gasses from within the container 11.

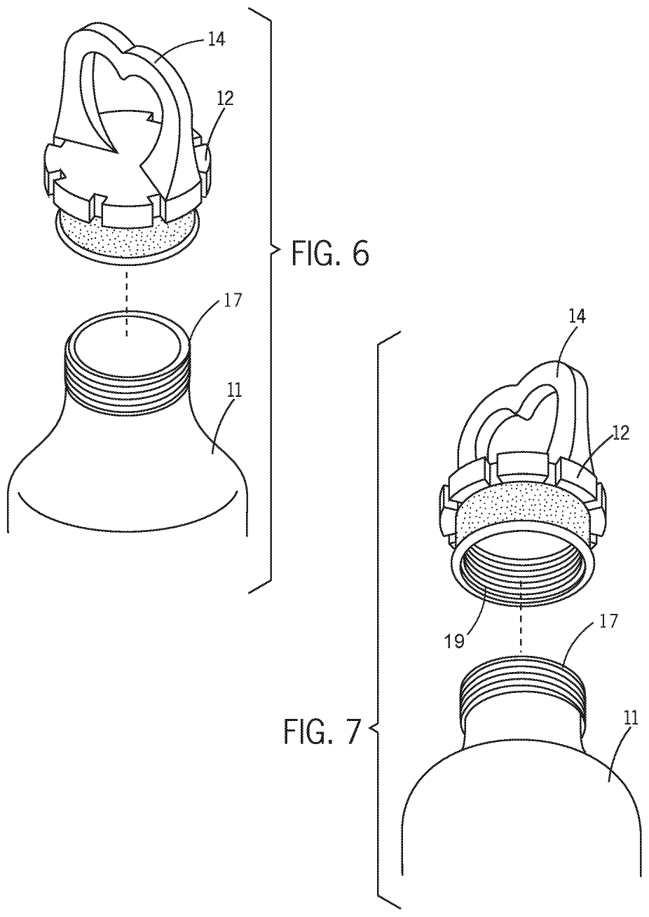

In other embodiments shown in reference to FIGS. 6 and 7, the safety cap 10 may include a plurality of threads 15 within the sleeve 18. The plurality of threads 15 are configured for threaded engagement with a cooperating plurality of threads 17 defined in the throat of the chemical container 11.

It should be understood, of course, that the foregoing relates to exemplary embodiments of the invention and that modifications may be made without departing from the spirit and scope of the invention as set forth in the following claims.

1. A cap for a container, comprising:
a base dimensioned to overly a peripheral rim surrounding a neck of the container;
a sleeve protruding from a bottom of the base, the sleeve dimensioned to sealingly engage with the neck of the container;
a handle extending from a top of the base, the handle dimensioned to be grasped by finger(s) of a user's hand to transport or hold the container via the cap; and
a plurality of notches defined in a spaced-apart relation about a circumferential edge surface of the base, the plurality of notches having opposed parallel faces adapted to receive a prong of a spanner wrench to facilitate a twisting of the cap when engaged within the neck of the container.

2. (canceled)

3. (canceled)

4. The cap of claim 1, further comprising:
a hose connector barb extending from the top of the base, the hose connector barb having a plurality of conical ridges disposed along a longitudinal length of the hose connector barb; and
a conduit extending through the hose connector barb and the base, the conduit providing a fluid path through the cap.

5. The cap of claim 4, further comprising:
a plurality of hose connector barbs extending from the top of the base.

6. The cap of claim 5, wherein the plurality of hose connector barbs are straight.

7. The cap of claim 4, further comprising:
a plurality of finger recesses defined in the handle and oriented to support the cap in an upright orientation when supported by a user's finger(s) received in the plurality of finger recesses.

8. The cap of claim 1, wherein the handle comprises an arch extending transversely across the base.

9. The cap of claim 7, wherein the plurality of finger recesses are defined in an inner surface of the arch.

10. The cap of claim 1, further comprising, an annular lip protruding from a bottom end of the sleeve.

11. A cap for a container, comprising:
a base dimensioned to overly a peripheral rim surrounding a neck of the container;
a sleeve protruding from and radially inset from a bottom of the base, the sleeve dimensioned to sealingly engage an exterior surface of the neck of the container;
a plurality of threads defined within the sleeve and configured for threaded engagement with a cooperating plurality of threads defined along neck of the container; and
a fixed or hinged handle extending from a top of the base, the handle dimensioned to be grasped by finger(s) of a user's hand to transport or hold the cap; and
a plurality of notches defined in a spaced-apart relation about a circumferential edge surface of the base, the plurality of notches having a depth extending proximal to the sleeve, and opposed parallel faces adapted to receive a prong of a spanner wrench to facilitate a twisting of the cap when engaged within the neck of the container.
